(19) United States
(12) Patent Application Publication
(10) Pub. No.: US 2025/0092987 A1
(43) Pub. Date: Mar. 20, 2025

(54) Corner Mounting Bracket Device

(71) Applicant: David Reyna, Wendell, NC (US)

(72) Inventor: David Reyna, Wendell, NC (US)

(21) Appl. No.: 18/887,739

(22) Filed: Sep. 17, 2024

Related U.S. Application Data
(60) Provisional application No. 63/583,669, filed on Sep. 19, 2023.

(51) Int. Cl. F16M 13/02; G01C 9/00

(52) U.S. Cl. CPC F16M 13/025; G01C 9/00

(57) ABSTRACT

A corner mounting bracket device is provided. The device is designed to be mounted on a wall corner, specifically a corner bead, for positioning various items such as cameras, laser levels, or projectors. The device comprises a body with a rear wall that includes at least one right-angled channel designed to fit around a metal corner bead, which may further incorporate a fastener such as a magnet to secure the device to the bead. To ensure precise placement, the device may also include an integrated level. The front wall features at least one mounting bracket, which can be fixedly or removably attached using a quick release locking mechanism, allowing easy attachment and repositioning of items to the device. The device is also designed to mitigate vibrations through various dampening features, such as rubberized pads or hydraulic dampers, to prevent any impact on the attached items.

### CROSS-REFERENCE TO RELATED APPLICATION

The present application claims priority to, and the benefit of, U.S. Provisional Application No. 63/583,669, which was filed on Sep. 19, 2023, and is incorporated herein by reference in its entirety.

### FIELD OF THE INVENTION

The present invention relates generally to the field of mounting devices. More specifically, the present invention relates to a corner mounting bracket device that attaches to a corner bead of a corner wall to allow various devices to be mounted in a suspended manner from a corner wall. Accordingly, the present disclosure makes specific reference thereto. Nonetheless, it is to be appreciated that aspects of the present invention are also equally applicable to other like applications, devices, and methods of manufacture.

### BACKGROUND

Mounting systems are commonly used in various settings to stabilize and position equipment such as cameras, laser levels, projectors, and other devices. Traditional mounting systems, such as tripods, are widely known for their flexibility and portability. However, these systems often require time-consuming setups involving multiple adjustments to attain the desired position and stability. Users must carefully adjust the tripod legs, lock various joints, and often fine-tune the device's alignment, which can be cumbersome, especially in time-sensitive or high-pressure situations. Furthermore, tripods and similar mounting systems are particularly susceptible to floor vibrations and external movements, which can compromise the accuracy and stability of mounted devices.

In addition to the setup difficulties and susceptibility to vibrations, traditional mounting systems can be obtrusive, occupying a significant amount of floor space. This is particularly problematic in confined or crowded environments, such as construction sites, small studios, or rooms with limited space for maneuverability. The bulkiness of these systems can also present a tripping hazard or interfere with other activities within the area. Despite these drawbacks, users have often had no choice but to rely on such mounting systems due to the lack of viable alternatives.

Moreover, many existing mounting solutions fail to utilize vertical spaces efficiently. Corners of walls, for example, are often underutilized in conventional mounting systems. Mounting a device on a corner can provide a stable and less intrusive solution, yet there are few, if any, practical devices available that leverage this potential.

Therefore, there exists a long-felt need in the art for an improved mounting system. There also exists a long-felt need in the art for a corner mounting bracket device that allows a user to securely mount an item on a corner of a wall. In addition, there exists a long-felt need in the art for a corner mounting device that allows a user to securely mount a device on a corner of a wall while also providing vibration resistance.

The subject matter disclosed and claimed herein, in one embodiment thereof, comprises a corner mounting bracket device. The device is designed to be mounted on a wall corner, specifically a corner bead, for positioning various items such as cameras, laser levels, or projectors. The device comprises a body with a rear wall that includes at least one right-angled channel designed to fit around a metal corner bead, which may further incorporate a fastener such as a magnet to secure the device to the bead. To ensure precise placement, the device may also include an integrated level. The front wall features at least one mounting bracket, which can be fixedly or removably attached using a quick release locking mechanism, allowing easy attachment and repositioning of items to the device. The device is also designed to mitigate vibrations through various dampening features, such as rubberized pads or hydraulic dampers, to prevent any impact on the attached items.

In this manner, the corner mounting bracket device of the present invention accomplishes all the forgoing objectives and provides an improved mounting system. More specifically, the device allows a user to securely mount an item on a corner of a wall. While doing so, the device also provides vibration resistance to protect and ensure the proper function of the item mounted to the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a corner mounting bracket device comprised of a body comprised of a rear wall. In one embodiment, the rear wall is comprised of at least one channel that can be placed around a metal corner bead of a wall. More specifically, to further attach the rear wall to the corner bead, the channel may be comprised of at least one fastener, such as but not limited to a magnet, that attaches to the corner bead to secure the device to the bead.

The front wall of the body is comprised of at least one mounting bracket. In one embodiment, the mounting bracket is fixedly attached to the front wall. In another embodiment, the bracket removably attaches to the front wall via at least one quick release locking mechanism that allows the mounting bracket to be detached from the body such that various items such as cameras, laser levels, projectors, etc. can be attached to the bracket and then back to the body while the body remains attached to a corner bead. This facilitates quick-change of various devices that need to be positioned on a corner wall. More specifically, at least one fastener, such as but not limited to a screw or a bolt, can be placed through at least one opening of the mounting bracket and into the item to secure the item to the bracket.

To mitigate the impact of vibrations, which may affect any item attached to the device, the device can be comprised of a plurality of features for vibration dampening. In one embodiment, the channel (or any other area of the device) can be comprised of at least one pad. The pad may include but is not limited to a rubberized pad, a silicone grommet or pad, a neoprene pad, etc. that absorbs kinetic energy from the corner bead and prevents said energy from being transferred to an item attached to the mounting bracket. The mounting bracket may alternatively or additionally be comprised of at least one dampening structure such as but not limited to a hydraulic damper or a spring.

The present invention is also comprised of a method of using the device. First, a device is provided comprised of a body comprised of a front wall comprised of a mounting bracket and a rear wall comprised of a channel and a fastener. Then, the channel of the rear wall can be secured to a metal corner bead of a corner wall via attaching the fastener to the corner bead. Then, an item can be secured to the mounting bracket by placing a fastener through an opening of the bracket and into the item, such that the item is suspended from the corner wall/corner bead.

Accordingly, the corner mounting bracket device of the present invention is particularly advantageous as it provides an improved mounting system. More specifically, the device allows a user to securely mount an item on a corner of a wall. While doing so, the device also provides vibration resistance to protect and ensure the proper function of the item mounted to the device. In this manner, the corner mounting bracket device provides a solution to mounting items effectively on a corner wall.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a corner mounting bracket device of the present invention in accordance with the disclosed architecture;

FIG. 2 illustrates a perspective view of one potential embodiment of a corner mounting bracket device of the present invention in accordance with the disclosed architecture;

FIG. 3 illustrates a flowchart of a method of using one potential embodiment of a corner mounting bracket device of the present invention in accordance with the disclosed architecture; and

FIG. 4 illustrates a flowchart of a method of using one potential embodiment of a corner mounting bracket device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved mounting system. There also exists a long-felt need in the art for a corner mounting bracket device that allows a user to securely mount an item on a corner of a wall. In addition, there exists a long-felt need in the art for a corner mounting device that allows a user to securely mount a device on a corner of a wall while also providing vibration resistance.

The present invention, in one exemplary embodiment, is comprised of a corner mounting bracket device. The device is comprised of a body comprised of a rear wall. The rear wall may be comprised of at least one channel that can be placed around a metal corner bead of a wall. To further attach the rear wall to the corner bead, the channel may be comprised of at least one fastener, such as but not limited to a magnet, that attaches to the corner bead to secure the device to the bead.

The front wall of the body is comprised of at least one mounting bracket that may be fixedly attached to the front wall. In another embodiment, the bracket removably attaches to the front wall via at least one quick release locking mechanism that allows the mounting bracket to be detached from the body such that various items such as cameras, laser levels, projectors, etc. can be attached to the bracket and then back to the body while the body remains attached to a corner bead. This facilitates quick-change of various devices that need to be positioned on a corner wall. More specifically, at least one fastener, such as but not limited to a screw or a bolt, can be placed through at least one opening of the mounting bracket and into the item to secure the item to the bracket.

To mitigate the impact of vibrations, which may affect any item attached to the device, the device can be comprised of a plurality of features for vibration dampening. In one embodiment, the channel (or any other area of the device) can be comprised of at least one pad. The pad may include but is not limited to a rubberized pad, a silicone grommet or pad, a neoprene pad, etc. that absorbs kinetic energy from the corner bead and prevents said energy from being transferred to an item attached to the mounting bracket. The mounting bracket may alternatively or additionally be comprised of at least one dampening structure such as but not limited to a hydraulic damper or a spring.

The present invention is also comprised of a method of using the device. First, a device is provided comprised of a body comprised of a front wall comprised of a mounting bracket and a rear wall comprised of a channel and a fastener. Then, the channel of the rear wall can be secured to a metal corner bead of a corner wall via attaching the fastener to the corner bead. Then, an item can be secured to the mounting bracket via placing a fastener through an opening of the bracket and into the item, such that the item is suspended from the corner wall/corner bead.

Accordingly, the corner mounting bracket device of the present invention is particularly advantageous as it provides an improved mounting system. More specifically, the device allows a user to securely mount an item on a corner of a wall. While doing so, the device also provides vibration resistance to protect and ensure the proper function of the item mounted to the device. In this manner, the corner mounting bracket device provides a solution to mounting items effectively on a corner wall.

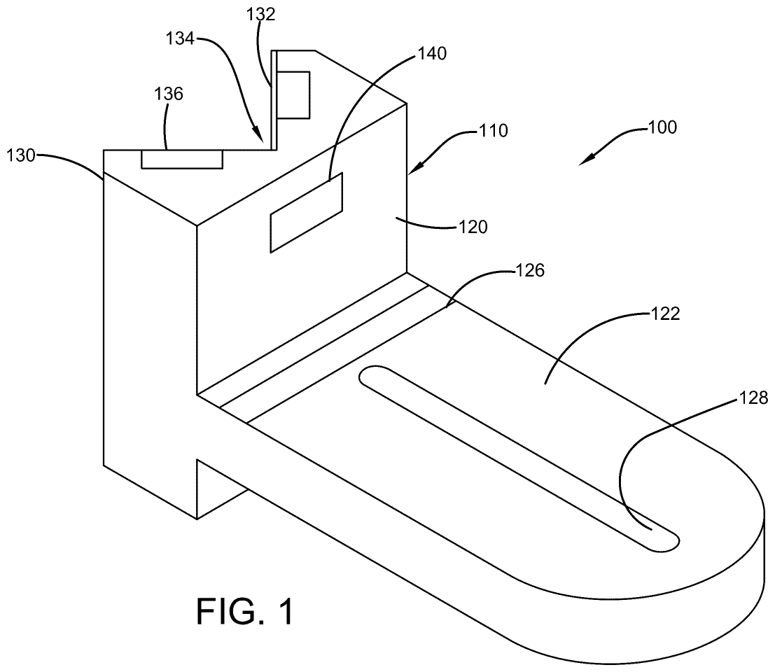

Referring initially to the drawings, FIG. 1 illustrates a perspective view of one potential embodiment of a corner mounting bracket device 100 of the present invention in accordance with the disclosed architecture. The device 100 is comprised of a body 110 that may be made from any material such as but not limited to a plastic, a metal, etc. The body 110 is comprised of a rear wall 130. In one embodiment, the rear wall 130 is comprised of at least one channel 134. The channel 134 is preferably right-angled such that the channel 134 can be placed around a metal corner bead of a wall.

More specifically, to further attach the rear wall 130 to the corner bead, the channel 134 may be comprised of at least one fastener 136, such as but not limited to a magnet, that attaches to the corner bead to secure the device 100 to the bead. It should be appreciated that the channel 134 may be any shape in different embodiments in order to attach and be secured to a corner bead or other wall corner location, style, etc. To facilitate proper positioning of the device 100 on a wall corner, the device 100 may be comprised of at least one integrated level 140, such as but not limited to a bubble level, a digital level, etc.

The front wall 120 of the body 110 is comprised of at least one mounting bracket 122. In one embodiment, the mounting bracket 122 is fixedly attached to the front wall 120. In another embodiment, the bracket 122 removably attaches to the front wall 120 via at least one quick release locking mechanism 124 such as but not limited to a button locking mechanism or a lever locking mechanism. The mechanism 124 allows the mounting bracket 122 to be detached from the body 110 such that various items such as cameras, laser levels, projectors, etc. can be attached to bracket 122 and then back to the body 110 while the body 110 remains attached to a corner bead. This facilitates quick-change of various devices that need to be positioned on a corner wall.

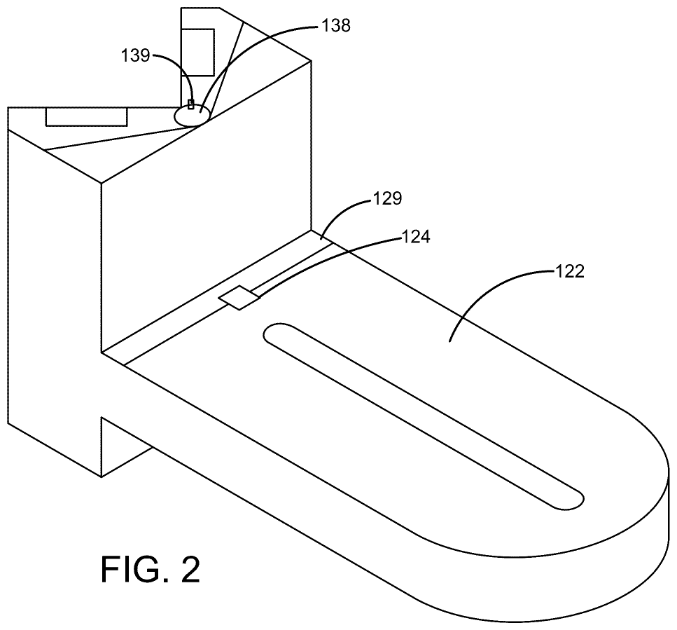

More specifically, at least one fastener, such as but not limited to a screw or a bolt, can be placed through at least one opening 128 of the mounting bracket 122 and into the item to secure the item to the bracket 122. In one embodiment, the locking mechanism 124 is positioned on at least one pivot point 129, as seen in FIG. 2, that attaches to the bracket 122 and allows the bracket 122 to be repositioned and tilted in at least one direction as needed to achieve proper item positioning. The point 129 may include but is not limited to a ball and socket joint, a hinge, etc.

To mitigate the impact of vibrations, which may affect any item attached to the device 100, the device 100 can be comprised of a plurality of features for vibration dampening. In one embodiment, the channel 134 (or any other area of the device 100) can be comprised of at least one pad 132. The pad 132 may include but is not limited to a rubberized pad, a silicone grommet or pad, a neoprene pad, etc. that absorbs kinetic energy from the corner bead and prevents said energy from being transferred to an item attached to the mounting bracket 122. The mounting bracket 122 may alternatively or additionally be comprised of at least one dampening structure 126 such as but not limited to a hydraulic damper or a spring.

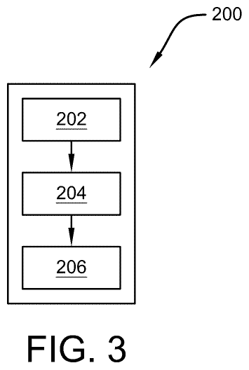

The present invention is also comprised of a method of using 200 the device 100, as seen in FIG. 3. First, a device 100 is provided comprised of a body 110 comprised of a front wall 120 comprised of a mounting bracket 122 and a rear wall 130 comprised of a channel 134 and a fastener 136 [Step 202]. Then, the channel 134 of the rear wall 130 can be secured to a metal corner bead of a corner wall via attaching the fastener 136 to the corner bead [Step 204]. Then, an item can be secured to the mounting bracket 122 via placing a fastener through an opening 128 of the bracket 122 and into the item, such that the item is suspended from the corner wall/corner bead [Step 206].

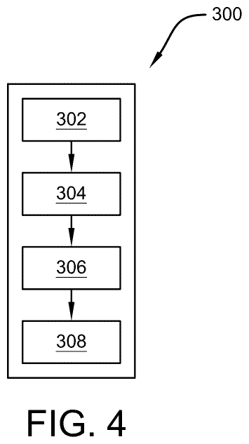

The present invention is also comprised of a second method of using 300 the device 100, as seen in FIG. 4. First, a device 100 is provided comprised of a body 110 comprised of a front wall 120 comprised of a mounting bracket 122 attached to the front wall 120 via a locking mechanism 124, and a rear wall 130 comprised of a channel 134 and a fastener 136 [Step 302]. Then, the channel 134 of the rear wall 130 can be secured to a metal corner bead of a corner wall via attaching the fastener 136 to the corner bead [Step 304]. Then, an item can be secured to the mounting bracket 122 via placing a fastener through an opening 128 of the bracket 122 [Step 306]. Next the mounting bracket 122, with the item secured to the bracket 122 can be attached to the front wall 120 via the locking mechanism 124 such that the item is suspended from the corner wall/corner bead [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “corner mounting bracket device” and “device” are interchangeable and refer to the corner mounting bracket device 100 of the present invention.

Notwithstanding the forgoing, the corner mounting bracket device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the corner mounting bracket device 100 as shown in the FIGS. are for illustrative purposes only, and that many other sizes and shapes of the corner mounting bracket device 100 are well within the scope of the present disclosure. Although the dimensions of the corner mounting bracket device 100 are important design parameters for user convenience, the corner mounting bracket device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A corner mounting bracket device comprising:
a body comprised of:
a front wall comprised of a mounting bracket, the mounting bracket comprised of an opening; and
a rear wall comprised of a channel, the channel comprised of a fastener.

2. The corner mounting bracket device of claim 1, wherein the channel is comprised of a right-angled channel.

3. The corner mounting bracket device of claim 1, wherein the fastener is comprised of a magnet.

4. The corner mounting bracket device of claim 1, wherein the body is comprised of a level.

5. The corner mounting bracket device of claim 4, wherein the level is comprised of a bubble level or a digital level.

6. A corner mounting bracket device comprising:
a body comprised of:
a front wall comprised of a mounting bracket removably attached to the front wall, the mounting bracket comprised of an opening; and
a rear wall comprised of a channel, the channel comprised of a fastener.

7. The corner mounting bracket device of claim 6, wherein the channel is comprised of a pad.

8. The corner mounting bracket device of claim 7, wherein the pad is comprised of a rubberized pad, a silicone grommet, a silicone pad, or a neoprene pad.

9. The corner mounting bracket device of claim 6, wherein the mounting bracket is comprised of a dampening structure.

10. The corner mounting bracket device of claim 9, wherein the dampening structure is comprised of a hydraulic damper or a spring.

11. The corner mounting bracket device of claim 6, wherein the mounting bracket attaches to the front wall via a repositionable pivot point.

12. The corner mounting bracket device of claim 11, wherein the pivot point is comprised of a ball and socket joint or a hinge.

13. The corner mounting bracket device of claim 11, wherein the pivot point is comprised of a first locking mechanism.

14. The corner mounting bracket device of claim 13, wherein the first locking mechanism is comprised of a button locking mechanism or a lever locking mechanism.

15. The corner mounting bracket device of claim 6, wherein the mounting bracket attaches to the front wall via a second locking mechanism.

16. The corner mounting bracket device of claim 15, wherein the first locking mechanism is comprised of a button locking mechanism or a lever locking mechanism.

17. A method of using a corner mounting bracket device, the method comprising:
providing a corner mounting bracket device comprised of a body comprised of a front wall comprised of a mounting bracket and a rear wall comprised of a channel and a fastener;
securing the channel to a corner bead via the fastener; and
securing an item to the mounting bracket.

18. The method of using a corner mounting bracket device of claim 17, wherein the channel is comprised of a right angle channel.

19. The method of using a corner mounting bracket device of claim 17, wherein the fastener is comprised of a magnet.

20. The method of using a corner mounting bracket device of claim 17, wherein the channel is comprised of a padding.
